(19) United States
(12) Patent Application Publication
(10) Pub. No.: US 2021/0054960 A1
(43) Pub. Date: Feb. 25, 2021

(54) Tri-Directional Mounting Bracket

(71) Applicant: Noah D. Glenn, Champlin, MN (US)

(72) Inventor: Noah D. Glenn, Champlin, MN (US)

(21) Appl. No.: 16/501,482

(22) Filed: Aug. 23, 2019

(51) Int. Cl. F16M 13/02

(52) U.S. Cl. CPC F16M 13/02

(57) ABSTRACT

The present invention discloses a tri-directional bracket. The bracket allows for electronic viewing devices, (such as televisions, monitors, tablets, ect . . . ), to be mounted in a symmetrical way allowing for full 360-degree visibility of the information on the electronic viewing device.

### INVENTION OVERVIEW

### Purpose of Invention

The purpose of the Tri-Directional Mounting Bracket is to allow individuals and businesses to mount display electronics, (such as televisions, monitors, tablets, ect . . . ), in a 360-degree way utilizing the triangular shape of the invention.

### Description of Problem(s) that this Invention Solves

The current solution on the market uses a simple bracket allowing individuals and businesses to mount display electronics, (such as televisions, monitors, tablets, ect . . . ), in a two-sided way (the electronic devices sit back to back to each other with the screens facing outward). The problem with the two-sided solution is that it is not a 360-Degree solution. Individuals at certain angles are not able to see the information that is being displayed on devices using a two-sided bracket.

### Description on how the Invention is an Improvement Over Existing Technology

The Tri-Directional Mounting Bracket is an improvement over existing technology because it allows individuals and businesses to mount display electronics, (such as televisions, monitors, tablets, ect . . . ), in a 360-degree way which is an improvement over the current two-sided solution that is available on the market today. Individuals at all angles can see the information that is being displayed on devices utilizing the Tri-Directional Mounting Bracket.

### Individual and Business Demographics that would Use this Invention

The Tri-Directional Mounting Bracket serves individuals and business in the following demographics: Tradeshows, high schools, colleges, wrestling (matside clock), basketball (courtside clock), volleyball (courtside clock), other sporting events that keep score and or time, government conventions, hotels, bars, concerts, other firms and entities that have information to display to large groups of people.

### Description of the Benefits of this Invention to its Users

The Tri-Directional Mounting Bracket benefits the users by allowing them to display their information in a better way. It allows the user's customer, fan, or guest to see the user's information from anywhere in the room or facility.

### Brief Description of the Invention

The Tri-Directional Mounting Bracket is made up of three rectangular pieces of steel welded together in the shape of a triangular prism, FIG. 1. There are triangular endcaps welded on both ends of the triangular prism, FIG. 2. A t-shaped handle welded to the top end cap, FIG. 4, while the bottom end cap has a hole cut in it (approximately 1.5 inch diameter), FIG. 5. There are also two triangular pieces of steel welded inside the body of the triangular prism, FIG. 2. One triangle has a hole in it (approximately 1.5 inch diameter) and acts as a guide while the other triangle is solid and acts as a stop, FIG. 2.

### BACKGROUND

The Tri-Directional Mounting Bracket solves several issues that prior art never addressed. The largest improvement is that the Tri-Directional Mounting Bracket allows individuals and businesses to display their information in a 360-degree way. By identifying and addressing this issue, the market for these types of products have expanded from a stationary desk mounted bracket holding up a computer monitor and a fixed wall mounted bracket holding up a television to sporting events (as a mobile scoreboard) and mobile information sites at conventions centers (along with many other use cases).

### BRIEF DESCRIPTION OF DRAWINGS

FIG. 1—Complete external view of Tri-Directional Mounting Bracket.

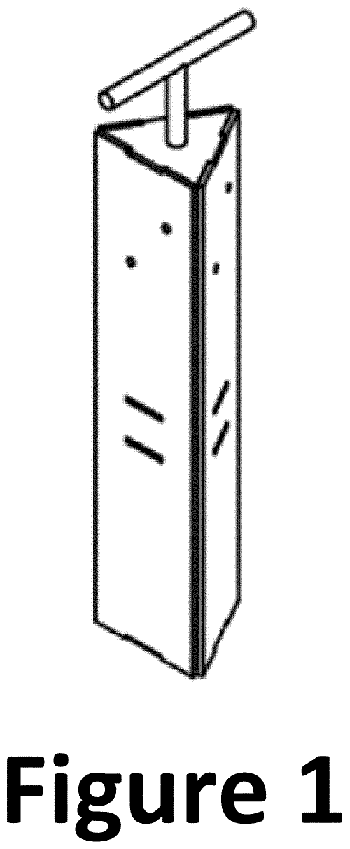

FIG. 2—Complete internal view of Tri-Directional Mounting Bracket.

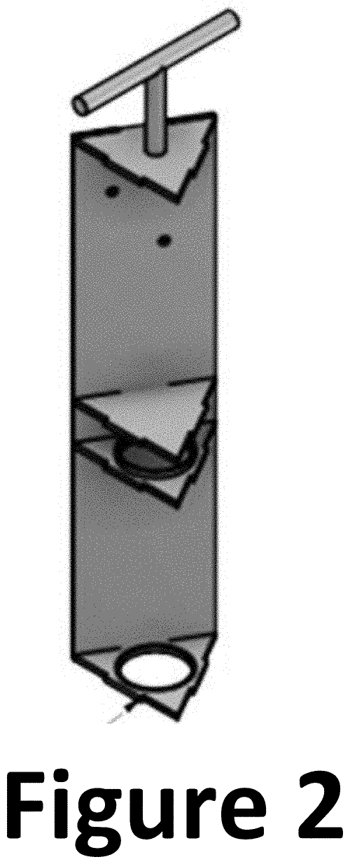

FIG. 3—Side view of Tri-Directional Mounting Bracket showing handle, laser-cut holes and slits.

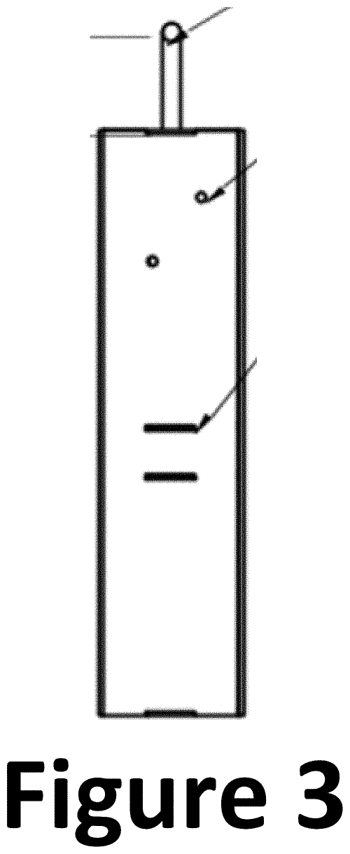

FIG. 4—Top view of Tri-Directional Mounting Bracket showing handle.

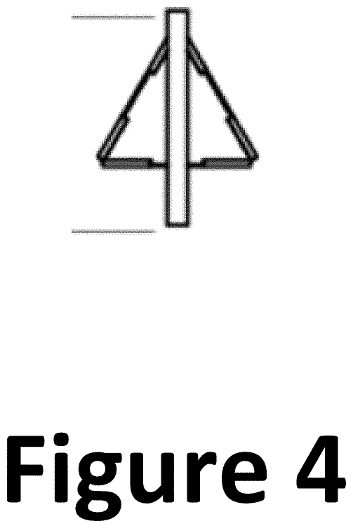

FIG. 5—Bottom view of Tri-Directional Mounting Bracket showing the hole in the base.

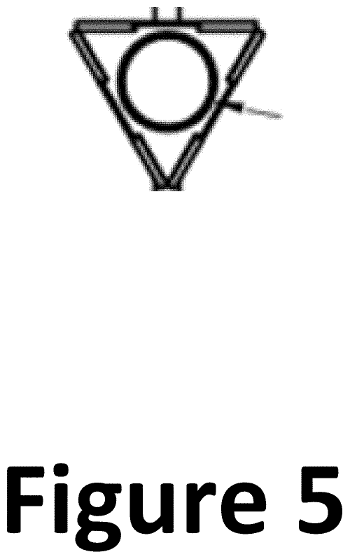

### DESCRIPTION OF RELATED ART

The present invention relates generally to a bracket that is used for mounting multiple electronic devices on the same fixture.

There are many inventions that have been registered in this regard. A Screw mounting jig is a U.S. Pat. No. 2,004,022,616,7A1 is issued to BenQ Corp. A screw mounting jig. The jig supports an electronic device thereon. The electronic device includes a first surface and a second surface opposite to the first surface. A first screw hole is formed on the first surface, and a second screw hole is formed on the second surface. The jig includes a base and a supporting assembly. The electronic device is received in the supporting assembly. The supporting assembly is disposed on the base in a manner such that it rotates between a first position and a second position. When the supporting assembly is located at the first position, the first surface faces the base so that the second screw hole is exposed for insertion. When the supporting assembly is located at the second position, the second surface faces the base so that the first screw hole is exposed for insertion.

An Electronic equipment mounting device is a U.S. Pat. No. 5,796,585A is issued to Toshiba Corp. The invention discloses an electronic equipment mounting device having flexibility in the mounting direction, the device is provided with a mounting jig on which a plurality of tongues are formed and a housing whose flat faces having different areas have slits in them, the tongues being inserted into the slits in a detachable manner. The mounting jig is mounted on, for example, the surface of a wall, and then the housing is coupled to the mounting jig by selectively using one of its side faces.

A Structure and jig for mounting spring arm on corresponding head arm is a U.S. Pat. No. 5,956,210A is issued to Fujitsu Ltd. A structure for mounting at least a spring arm on at least a head arm is disclosed, which can meet the requirement for high recording density in a disk apparatus by effectively reducing the vibration of the head unit in operation. A head actuator includes at least a pair of heads mounted at the forward end of the head arm through the spring arm for reading/writing information in a discoidal recording medium.

The base of the spring arm is fixedly welded to a fixing member. The head arm and the fixing member are coupled to each other by a caulking protrusion as a coupler formed on the fixing member. The overlapped portion of the head arm and the fixing member other than the coupler is formed with a vibration damping layer for preventing vibrations of one of the head arm and the fixing member from propagating to the other. This vibration damping layer is composed of a simple air gap or a vibration damping material filled in the air gap.

The current invention is a tri-directional mounting bracket. It is made up of a thin steel shaped in a triangular prism where brackets for three electronic viewing devices are attached to each face in a symmetrical way that provides a full 360-degree visibility of the message on the electronic viewing devices.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of a mounting bracket for multiple electronic viewing devices.

It is the most important objective of the invention is to provide a mounting bracket which provides tri-directional mounting feature through a single assembly.

Another objective is to provide a mounting jig that is simple and easy to use.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The current invention proposes to provide a tri-directional mounting bracket. The invention as per preferred embodiment of the invention is an assembly which has three surfaces to receive the connections to the electronic viewing devices.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: A mounting bracket for supporting multiple electronic viewing device, wherein an electronic viewing device gets mounted to the bracket on the first surface, a different electronic viewing device gets mounted to the bracket on the second surface, and a third electronic viewing devices gets mounted to the bracket on the third surface.
